(19) United States
(12) Patent Application Publication
(10) Pub. No.: US 2024/0254921 A1
(43) Pub. Date: Aug. 1, 2024

(54) SYSTEMS AND METHODS FOR COOLING SEAWATER FOR HEAT EXCHANGE PROCESSES

(71) Applicant: EXXONMOBIL TECHNOLOGY AND ENGINEERING COMPANY, Spring, TX (US)

(72) Inventors: Maciej Z. LUKAWSKI, Houston, TX (US); Marcel STAEDTER, Houston, TX (US)

(73) Assignee: EXXONMOBIL TECHNOLOGY AND ENGINEERING COMPANY, Spring, TX (US)

(21) Appl. No.: 18/560,890

(22) PCT Filed: May 2, 2022
(86) PCT No.: PCT/US2022/072032

§ 371 Date: Nov. 14, 2023

Related U.S. Application Data
(60) Provisional application No. 63/201,987, filed on May 21, 2021.

(51) Int. Cl. F02C 7/143; F02C 3/22; F02C 7/224

(52) U.S. Cl. CPC F02C 7/143; F02C 3/22; F02C 7/224

(57) ABSTRACT

Chilled seawater formed through interaction with a liquefied gas vaporizer may facilitate various types of heat exchange processes. The extent to which the seawater may be cooled is often limited by local environmental regulations for discharging the seawater once heat exchange has taken place. The foregoing issues may be addressed by systems comprising a liquefied gas vaporizer; a supply line configured to distribute seawater upon the liquefied gas vaporizer; a collection reservoir below the liquefied gas vaporizer configured to gather chilled seawater passing therethrough; a heat exchanger in fluid communication with the collection reservoir; and a heat exchanger outlet line configured to discharge heat-exchanged seawater to a sea location. The heat exchanger may be in direct or indirect thermal communication with a flow pathway for air provided to a gas engine or gas turbine, which may alter speed, power or efficiency of the gas engine or gas turbine.

### CROSS REFERENCE TO RELATED APPLICATIONS

This application claims the priority benefit of U.S. Provisional Patent Application No. 63/201,987, filed May 21, 2021, entitled systems and methods for systems and methods for systems and methods for SYSTEMS AND METHODS FOR COOLING SEAWATER FOR HEAT EXCHANGE PROCESSES, the entirety of which is incorporated by reference herein.

### FIELD

The present disclosure relates to cooling seawater for heat exchange processes.

### BACKGROUND

High-temperature inlet air may decrease both the power output and efficiency of gas engines, including gas turbines. For example, the power output of gas turbines may decrease by up to about 10% for industrial gas turbines and up to about 25% for aeroderivative turbines upon the inlet air temperature increasing by about 40° F. (e.g., from 60° F. (16° C.) to 100° F. (38° C.)). There may also be seasonal variation in the power output and efficiency of gas engines and gas turbines.

The foregoing issue may be mitigated to at least some degree by using engine inlet air cooling (EIAC) systems, sometimes referred to as turbine inlet air cooling (TIAC) systems when applied to gas turbines. Many types of engine (turbine) inlet air cooling systems utilize vapor compression chillers or vapor absorption chillers to lower the temperature of inlet air in order to afford less capacity fluctuation and more efficient operation of a gas engine or gas turbine. In the case of natural gas processing, an alternative approach employing vaporization of liquefied natural gas may be more effective in many instances. Other gas vaporization processes may likewise facilitate cooling of engine or turbine inlet air.

Gas turbines are frequently employed in natural gas processing, such as for compressing a natural gas stream to form liquefied natural gas (LNG) for transportation or other purposes. After forming LNG, the LNG may be transported to an onshore, nearshore, or floating receiving terminal and undergo vaporization to re-form a gaseous state. Seawater is a commonly used medium for promoting heating of LNG to re-form the gaseous state. Open rack vaporizers (ORV) or other types of suitable gas vaporizers may be contacted with seawater to promote heating of the LNG to effect this phase change from an initial cryogenic liquid state. In the case of ORVs, a seawater stream may be sprayed or poured upon tubes containing LNG to promote heating and vaporization, and chilled seawater may then be gathered in a collection reservoir below the ORV for subsequent discharge to a sea location. Vaporization of other liquefied gases may similarly promote formation of chilled seawater. One difficulty associated with the foregoing process is that environmental regulations may limit the temperature differential between discharged seawater and that provided to an ORV. Depending on local regulations, the temperature differential at a specified position relative to a seawater outlet may be limited to about 5-7° C. The specified position may allow some intermixing with ambient seawater to take place before measuring the temperature at the specified position to determine the temperature differential.

Chilled seawater obtained following heat exchange in a liquefied gas vaporizer may be utilized to promote various heat exchange operations, such as indirect cooling of inlet air provided to a gas engine or gas turbine, which may be associated with an LNG receiving process or an unrelated process, especially when the ambient air temperature is high. Such a process is described in JP2000145476, wherein chilled seawater undergoes heat exchange with an elevated-temperature cooling fluid returning from a gas turbine, and the resulting heat-exchanged seawater is then recycled upstream for promoting further vaporization in the LNG vaporizer. The amount of seawater used for promoting LNG vaporization in the LNG vaporizer may exceed that needed for promoting downstream heat exchange, and excess chilled seawater eventually needs to be discharged to a sea location. This action may result in discharge of significant volumes of chilled seawater having a temperature considerably below the local seawater temperature and at relatively high discharge flow rates. As such, the extent of inlet air cooling or other heat exchange that may take place in this manner is tempered by the extent of seawater cooling that initially takes place, which is, in turn, limited by the above-noted environmental regulations for the seawater discharge temperature differential. More specifically, in conventional seawater-based cooling processes, the temperature of the inlet air cannot be cooled below the discharge temperature of the seawater, thereby decreasing the available power output and efficiency.

### SUMMARY

The present disclosure provides systems comprising: a liquefied gas vaporizer; a seawater inlet coupled to a supply line configured to distribute seawater upon the liquefied gas vaporizer; a collection reservoir below the liquefied gas vaporizer that is configured to gather chilled seawater passing through the liquefied gas vaporizer; a heat exchanger in fluid communication with the collection reservoir via a reservoir outlet line; and a heat exchanger outlet line coupled to a seawater outlet configured to discharge heat-exchanged seawater to a sea location.

In some or other embodiments, methods of the present disclosure may comprise: providing a flow of liquefied gas in a liquefied gas vaporizer; introducing seawater to a supply line via a seawater inlet; distributing a stream of seawater from the supply line upon the liquefied gas vaporizer, thereby lowering the seawater from a first temperature to a second temperature and forming chilled seawater; gathering the chilled seawater at about the second temperature in a collection reservoir below the liquefied gas vaporizer; supplying a stream of chilled seawater from the collection reservoir to a heat exchanger, the chilled seawater being heated from the second temperature to a third temperature in the heat exchanger and forming heat-exchanged seawater; and removing a stream of heat-exchanged seawater from the heat exchanger via a heat exchanger outlet line.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 is a diagram of an illustrative system and method for cooling inlet air supplied to a gas engine or gas turbine using seawater chilled in a liquefied gas vaporizer.

FIG. 2 is a diagram of an illustrative system and method for cooling inlet air supplied to a gas engine or gas turbine using seawater chilled in a liquefied gas vaporizer divided into sections.

FIG. 3 is a diagram of an illustrative system and method for cooling inlet air supplied to a gas engine or gas turbine using a secondary heat transfer fluid cooled with seawater chilled in a liquefied gas vaporizer.

FIG. 4 is a diagram of an illustrative system and method for cooling inlet air supplied to a gas engine or gas turbine using a secondary heat transfer fluid cooled with seawater chilled in a liquefied gas vaporizer divided into sections.

### DETAILED DESCRIPTION

The present disclosure generally relates to heat exchange and, more particularly, methods and systems for cooling seawater for promoting heat exchange, in which discharged seawater is maintained within a desired temperature differential. Seawater cooled according to the disclosure herein may promote cooling of inlet air for gas engines and gas turbines to promote more efficient operation and improve power output thereof.

As discussed above, cooling of inlet air for gas engines and gas turbines may facilitate higher, more consistent power output and more effective operation thereof. One way in which inlet air cooling may be realized is through seawater-promoted vaporization of liquefied natural gas (LNG) in an LNG vaporizer, followed by utilizing chilled seawater obtained therefrom to promote the inlet air cooling, as described in JP2000145476. A difficulty with this conventional approach and similar inlet air cooling approaches is that chilled seawater eventually needs to be discharged to a sea location, and environmental regulations may limit the temperature differential between discharged seawater and that provided to the LNG vaporizer. Consequently, the amount of inlet air cooling that the seawater may provide is limited by the extent to which the seawater may be cooled during LNG vaporization. In many instances, the discharged seawater may not differ by more than about 5° C. in temperature from the seawater provided to the LNG vaporizer (i.e., the surrounding seawater). The seawater inlet temperature less than approximately 5° C. temperature differential thus represents the lowest possible temperature to which engine inlet air may be cooled in conventional inlet air cooling configurations. In practice, the inlet air temperature reached with seawater cooling may be higher than this minimum value due to additional heat exchange operations that may take place. Depending on ambient air temperatures, this limitation may significantly curtail engine/turbine capacity (power output) and efficiency.

The present disclosure provides various systems and methods that may alleviate the foregoing difficulties. In particular, the present disclosure provides systems and methods for promoting inlet air cooling for gas engines and gas turbines, either directly or indirectly, using chilled seawater obtained from an LNG vaporizer, while effectively controlling the temperature of seawater subsequently discharged to a surrounding sea location. That is, the present disclosure provides a synergistic coupling between LNG vaporization and inlet air cooling for a gas engine or turbine. Vaporization of other cryogenic liquids, such as liquid hydrogen, may also promote inlet air cooling. In addition, chilled seawater formed according to the disclosure herein may be utilized in heat exchange processes other than inlet air cooling.

Advantageously, temperature control of the discharged seawater and targeted inlet air temperatures may be accomplished in the disclosure herein without employing external heaters or refrigeration separate from those possibly used in other process locations. Instead, when needed, temperature control may be realized by mixing heat-exchanged seawater with a portion of the chilled seawater obtained from the LNG vaporizer and/or seawater diverted from being chilled in the LNG vaporizer. Thus, the temperature of the discharged seawater may be increased or decreased as operational needs dictate. By regulating the discharge temperature of the heat-exchanged seawater in the foregoing manner, the chilled seawater obtained from the LNG vaporizer or a similar liquefied gas vaporizer may be cooled more extensively, thereby allowing more effective inlet air cooling or related heat exchange to take place. Lower discharge flow rates may advantageously be realized through implementation of the present disclosure. Chilled seawater provided to the inlet air or other heat exchange location may also be heated to an extent that meets seawater discharge temperature regulations. Further advantageously, the systems and methods of the present disclosure may more effectively accommodate seasonal temperature variations to levelize performance of a gas engine or gas turbine. Moreover, the systems and methods of the present disclosure may facilitate greater power output and more efficient operation of gas engines and gas turbines to lessen the need for excess turbine capacity, which may decrease capital expenditure in various cases.

Alternately, by varying the temperature of chilled water obtained from a LNG vaporizer or similar liquefied gas vaporizer, the systems and methods of the present disclosure may allow the performance of a gas engine or gas turbine to be altered from its normal operational stage. For example, the chilled water temperature may be varied to modulate (increase or decrease) power output in response to fluctuation in power demand. This feature may improve overall power efficiency and facilitate additional power output when needed. Advantageously, temperature control of the chilled water obtained from the LNG or similar liquefied gas vaporizer may be realized simply by altering the flow rate of seawater provided thereto.

As used herein, the term “natural gas” refers to a multi-component gas obtained from a crude oil well (associated gas) or from a subterranean gas-bearing formation (non-associated gas). The composition and pressure of natural gas can vary significantly. A typical natural gas stream contains methane as a significant component, sometimes as a primary component. A natural gas stream may also contain ethane, higher molecular weight hydrocarbons (e.g., propane), and/or one or more acid gases. Minor amounts of contaminants such as water, nitrogen, iron sulfide, wax, and crude oil, for example, may also be present. One or more of these components may be removed and/or lessened in concentration prior to processing a natural gas stream. Liquefied natural gas (LNG) may comprise predominantly methane after undergoing processing. Preferably, processed natural gas is substantially free of water and carbon dioxide. More preferably, processed natural gas has a maximum C₅₊ content of about 1000 ppmv (parts per million by volume) and a benzene content of less than about 1 ppmv.

As used herein, the term “fuel gas” refers to a gaseous fuel that may be combusted to power a gas engine or gas turbine.

As used herein, the term “gas engine” refers to any type of internal combustion engine that utilizes a gaseous fuel, such as hydrogen, natural gas, a combination thereof, or the like to produce work.

As used herein, the term “gas turbine” refers to a coupled gas compressor, combustor, and turbine, in which air is pressurized and combined with fuel, and the fuel is combusted to provide a high-temperature pressurized gas stream. The high-temperature pressurized gas stream is then provided to a turbine having a common shaft with the gas compressor. Excess energy in the form of exhaust gas(es) may be utilized for performing external work. Gas turbines may include industrial gas turbines, aeroderivative gas turbines, or turbines operating in a combined cycle.

As used herein, the term “cooling” refers to lowering and/or dropping the temperature and/or internal energy of a substance by any suitable, desired, or required amount. In the case of air, cooling may also involve condensation and/or removal of moisture from air.

As used herein, the term “heat exchanger” refers to any device capable of transferring thermal energy from one medium to another medium. Two heat exchangers may also be in thermal communication with one another to promote the heat transfer. When a single heat exchanger is in direct contact with a medium in need of heat exchange, the heat exchange is classified as “direct” in the disclosure herein. When two heat exchangers are in thermal communication with one another, particularly through use of an intermediate heat transfer fluid, and a medium in need of heat exchange is in direct contact with the second heat exchanger but not the first heat exchanger, the heat exchange is classified as “indirect” in the disclosure herein.

As used herein, the term “temperature differential” refers to the absolute value of the difference in temperature between a first location and a second location. Thus, the temperature at the second location may be greater than, less than, or equal to the temperature in the first location.

As used herein, the term “seawater” refers to water obtained from an oceanic environment or a location near an oceanic environment having at least some degree of salinity. Oceanic environments include, but are not limited to, oceans, seas, gulfs, bays, sounds, brackish estuaries, freshwater estuaries, saltwater marshes and swamps, brackish marshes and swamps, tidal marshes and swamps, freshwater marshes and swamps, and the like.

It is to be appreciated that any embodiment described herein as employing seawater or discharging seawater to a sea location may be practiced equivalently using freshwater and discharging freshwater to a freshwater location. Moreover, seawater need not necessarily be obtained directly from an oceanic source, as numerous locations near an oceanic source may provide water functionally equivalent to seawater and usable in conjunction with the systems and methods herein.

Embodiments of the present disclosure will now be described in further detail with reference to the drawings.

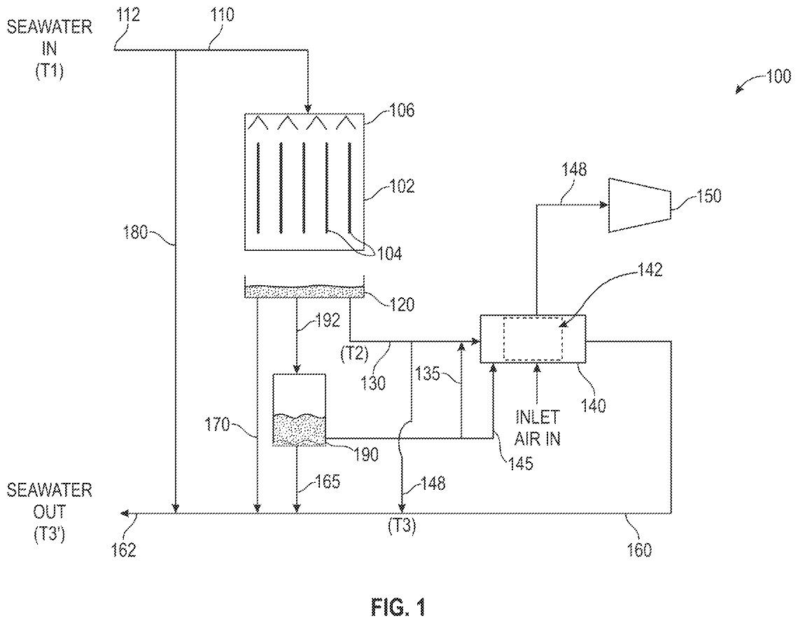

FIG. 1 is a diagram of an illustrative system and method for cooling inlet air supplied to a gas engine or gas turbine using seawater chilled in a liquefied gas vaporizer. As shown in FIG. 1, system and method 100 includes open rack liquefied gas vaporizer 102 or another type of liquefied gas vaporizer, such as an LNG vaporizer or a liquefied hydrogen vaporizer. Open rack liquefied gas vaporizer 102 includes tubes 104, in which a feed of a liquefied gas (e.g., natural gas and/or hydrogen) undergoes vaporization (liquefied gas feed and vaporized gas withdrawal not shown) following exposure to a liquid provided from distributor 106. Seawater is introduced to supply line 110 via inlet end 112 and is provided to distributor 106. Entering seawater is at a first temperature (T1) in supply line 110 when supplied to distributor 106. As the seawater passes through open rack liquefied gas vaporizer 102, the seawater contacts tubes 104 and heats the liquefied gas therein. The seawater undergoes cooling as a result, and chilled seawater gathers in collection reservoir 120 below open rack LNG vaporizer 102. Chilled seawater in collection reservoir 120 is at a second temperature (T2) that is lower than the first temperature (T1).

At least a portion of the chilled seawater in collection reservoir 120 is conveyed via reservoir outlet line 130 to heat exchanger 140, which may include one or more cooling channels for receiving the chilled seawater to promote cooling of inlet air. Suitable heat exchanger types and cooling channel configurations therein are not believed to be particularly limited. Although shown in FIG. 1 as being coupled to flow pathway 142 for cooling inlet air, it is to be appreciated that the concepts described herein may also be applicable to performing alternative heat exchange processes. Thus, when performing alternative heat exchange processes, flow pathway 142 for cooling inlet air need not be present.

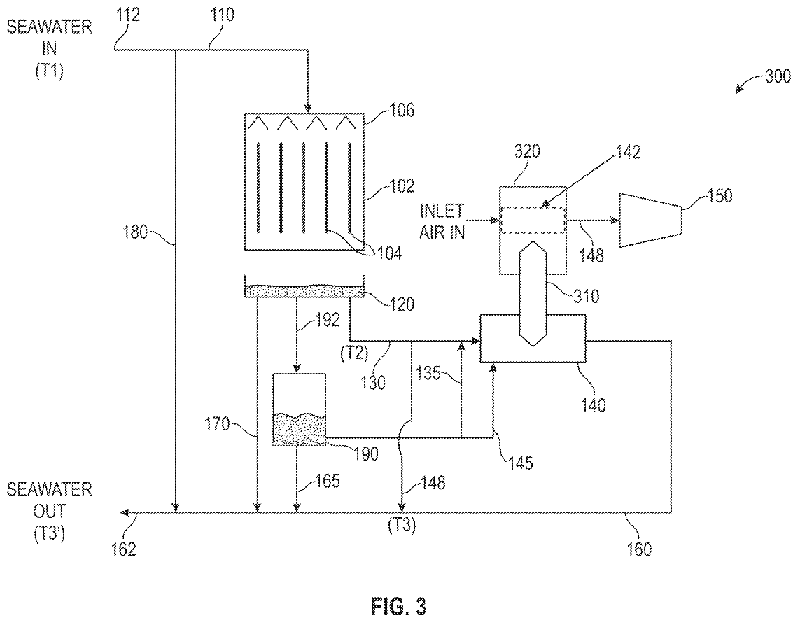

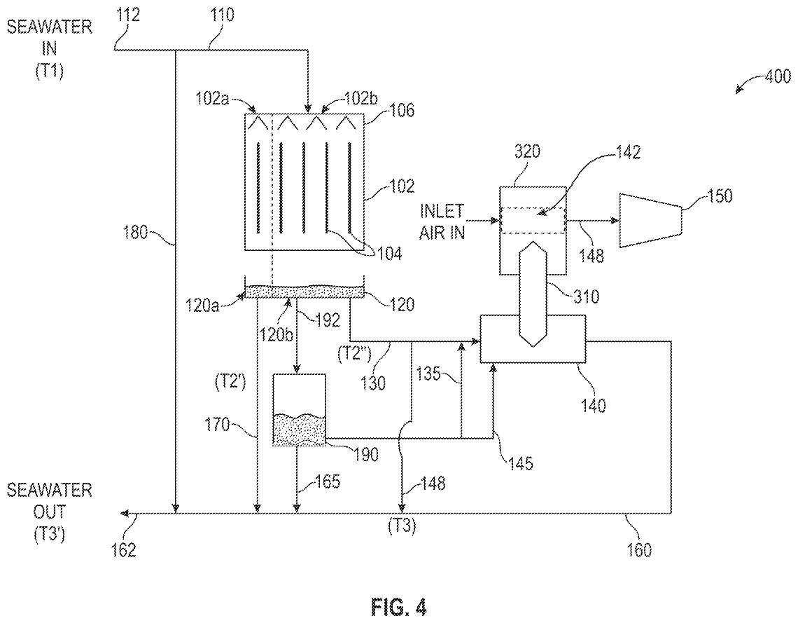

Heat exchanger 140 is in thermal communication with flow pathway 142. As presented in FIG. 1, flow pathway 142 is integral with heat exchanger 140, but it is to be recognized that flow pathway 142 may reside upon the exterior of heat exchanger 140 or be separate from heat exchanger 140 altogether. FIGS. 3 and 4, discussed further below, show a type of system and method configuration in which heat exchanger 140 may be spaced apart from flow pathway 142 while remaining in thermal communication therewith. Inlet air passing through flow pathway 142 undergoes heat exchange with the chilled seawater and is then provided to gas engine or gas turbine 150 via line 148. Following heat exchange, the resulting cooled inlet air may promote more effective operation of gas engine or gas turbine 150.

After promoting cooling of the inlet air in flow pathway 142, heat-exchanged seawater exits heat exchanger 140 via heat exchanger outlet line 160 and is subsequently discharged to a sea location via outlet end 162. Upon exiting heat exchanger 140, the heat-exchanged seawater is at a third temperature (T3) that is higher than the second temperature (T2). The third temperature (T3) is often lower than the first temperature (T1), but may be higher in some cases. For example, if the ambient temperature is high, the third temperature (T3) may be higher than the first temperature (T1). If the temperature differential between the first temperature (T1) and the third temperature (T3) is sufficiently small, preferably about 5° C. or less (such as cases where the third temperature (T3) is up to about 5° C. lower than the first temperature (T1)), the heat-exchanged seawater in heat exchanger outlet line 160 may be directly discharged to the sea location. In contrast, if the temperature differential for heat-exchanged seawater in supply line 110 relative to that in heat-exchanged outlet line 160 is above a specified threshold (e.g., greater than about 5° C. or a similar value based upon local environmental regulations, such as T3 being about 5° C. or lower than T1), measurement of the actual seawater temperature differential at a specified position relative to outlet end 162 may determine if compliance with temperature differential regulations is met at the specified position (e.g., less than about 5° C.). Thermal dispersion at outlet end 162 may determine the ultimate temperature differential achieved between ambient seawater in supply line 110 and seawater discharged from heat-exchanged outlet line 160, with the temperature differential being established based upon a temperature measurement at the specified position. Site-specific conditions, a discharge flow rate of heat-exchanged seawater, and local regulations, including the definition of a suitable dispersion zone beyond outlet end 162, may determine the ultimate temperature differential that may be present in a given locale. In other words, the temperature differential may exceed a specified value while the heat-exchanged seawater is still in heat-exchanged outlet line 160, but after mixing with ambient seawater takes place at the sea location, the temperature differential may still meet local temperature differential regulations. In non-limiting examples, the temperature differential at the specified position relative to outlet end 162 in comparison to the temperature at inlet end 112 may be about 5° C. or less. That is, the seawater temperature at a specified position relative to outlet end 162 may have a temperature T3′, which may be greater than, less than, or equal to T3, preferably wherein T1-T3′ is about 0° to about −5° C. If the seawater temperature at the specified position is excessively high, the circulation rate of seawater within system 100 may be decreased to allow greater temperature reduction of seawater to take place, thereby affording even further increased gas turbine or gas engine efficiency and power output. Conversely, if the seawater temperature at the specified position is excessively below the temperature of ambient seawater (e.g., about 5° C. or more below the temperature of ambient seawater), the circulation rate of seawater within system and method 100 may be increased to promote less temperature reduction in open rack liquefied gas vaporizer 102 and a higher discharge rate from outlet 162.

If T3 or T3′ is not at a desired value, system and method 100 includes provisions for adjusting the seawater temperature in heat exchanger outlet line 160. One way in which the temperature in heat exchanger outlet line 160 may be regulated is through controlled release of excess chilled seawater from collection reservoir 120 via discharge line 170, thereby lowering the temperature of heat-exchanged seawater within heat exchanger outlet line 160. In particular, chilled seawater may be released from collection reservoir 120 at a rate sufficient to preclude overflow of collection reservoir 120. Moreover, the rate of chilled seawater release from collection reservoir 120 may be selected to maintain the temperature differential T1-T3 or T1-T3′ within desired limits. Optionally, additional temperature regulation may be afforded by providing seawater from supply line 110 to heat exchanger outlet line 160 via bypass line 180. For example, if chilled seawater released from collection reservoir 120 lowers the temperature excessively in heat exchanger outlet line 160, the excessive temperature decrease may be modulated by introducing unchilled seawater via bypass line 180. Additional temperature regulation within system and method 100 may be realized by varying the overall seawater flow rate therethrough.

In another instance, bypass line 180 may be utilized to bypass open rack liquefied gas vaporizer 102 when the ambient air temperature is already low, and cooling of inlet air to a gas engine or gas turbine is not needed at a particular point in time. Liquefied gas vaporizer 102 may also be bypassed by at least a portion of the seawater in supply line 110 when demand for vaporized gas is low (e.g., fuel gas demand is low). Moreover, the amount of seawater being provided to open rack liquefied gas vaporizer 102 may be regulated by the extent of seawater diverted to heat exchanger outlet line 160 via bypass line 180. In addition to regulating the volume of seawater being provided to open rack liquefied gas vaporizer 102, flow rates within open rack liquefied gas vaporizer 102 may be regulated to adjust the extent of seawater cooling therein as well.

Additional components and functionality may also be present to provide further tailoring of the seawater temperature and operational flexibility within system and method 100. Optionally, chilled seawater from collection reservoir 120 may be transferred to chilled seawater holding tank 190 via line 192. Chilled seawater holding tank 190 may serve as a thermal reservoir, as well as provide a source for providing additional thermal regulation within system and method 100. As shown, chilled seawater holding tank 190 may distribute chilled seawater to any of reservoir outlet line 130, heat exchanger 140, or heat exchanger outlet line 160 via lines 135, 145 and 165, respectively. Another optional feature is bypass line 148, which allows chilled seawater to bypass heat exchanger 140 by being shunted to heat exchanger outlet line 160.

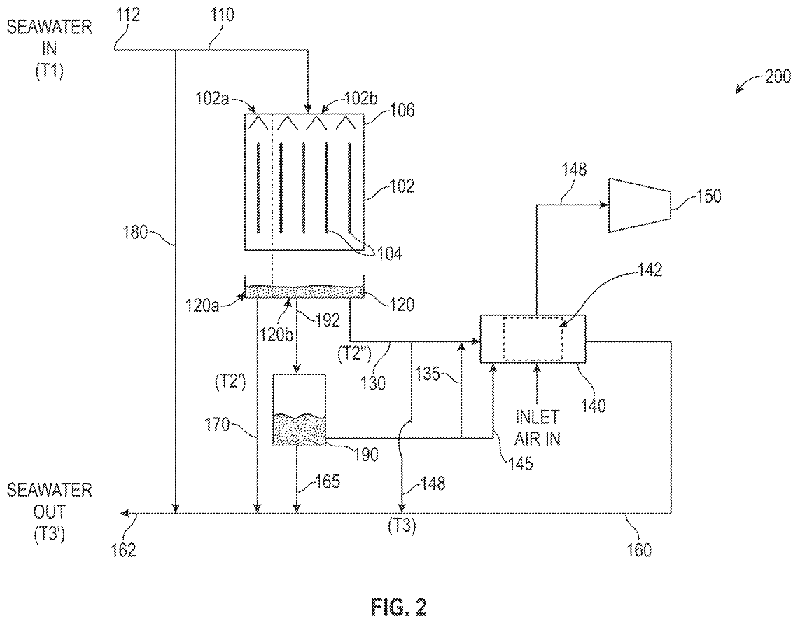

Additional system and method variations are described hereinafter in reference to FIGS. 2-4. Identical reference characters are used in FIGS. 2-4 for annotating in-common elements having similar features to those described above in FIG. 1. Moreover, in the interest of brevity, elements in FIGS. 2-4 having similar operational characteristics to those described above in FIG. 1 are not described again in detail.

FIG. 2 is a diagram of an illustrative system and method for cooling inlet air supplied to a gas engine or gas turbine using seawater chilled in a liquefied gas vaporizer divided into sections. System and method 200 depicted in FIG. 2 is identical to that presented in FIG. 1, except open rack liquefied gas vaporizer 102 and collection reservoir 120 are subdivided into sections 102a and 102b, and 120a and 120b, respectively. By subdividing open rack liquefied gas vaporizer 102 and collection reservoir 120, more extensive cooling may take place in one section of open rack liquefied gas vaporizer 102 than in the other. Moreover, by keeping the chilled seawater effluent from open rack liquefied gas vaporizer 102 separate in collection reservoir 120 (i.e., in sections 120a and 120b, where intermixing between the two does not take place), less flow regulation may be needed when returning chilled seawater to heat exchanger outlet line 160 via discharge line 170. For example, in the configuration depicted in FIG. 2, sections 102b and 120b may be sized to provide a desired extent of inlet air cooling, such that the chilled seawater supplied to heat exchanger 140 is available at a required temperature and/or flow rate to meet cooling duty requirements. In this configuration, heat exchanger 140 does not rely on seawater collected in section 120a to provide a supply of chilled seawater for cooling duty. The seawater volume collected in section 120a may be determined by vaporization (regasification) duty and other operational considerations. Provided that the temperature of the chilled seawater in section 120a (T2′) is higher than that in section 120b (T2″), the chilled seawater in section 120a may be returned to heat exchanger outlet line 160 with less risk of thermal disruption than in the configuration of system and method 100 in FIG. 1. More extensive cooling of the chilled seawater in sections 102b and 120b may be accomplished by providing a lower seawater flow rate to section 102b of open rack LNG vaporizer 102 via distributor 106, thereby allowing the smaller seawater volume to undergo more extensive cooling when contacted with tubes 104. It is to be appreciated that while sections 102a/120a and 102b/120b are shown in FIG. 2 as having different sizes, they can alternately be substantially the same size. Moreover, either of sections 102a,120a or 102b,120b may be larger when sized differently.

In an alternative configuration to system and method 100 in FIG. 2, instead of being subdivided, two separate open rack LNG vaporizers 102 and two separate collection reservoirs may be provided. Such a system and method configuration may operate in a substantially similar manner to that described above in reference to FIG. 2, and such operation will not be described in detail again in the interest of brevity.

FIG. 3 is a diagram of an illustrative system and method for cooling inlet air supplied to a gas engine or gas turbine using a secondary heat transfer fluid cooled with seawater chilled in a liquefied gas vaporizer. System and method 300 depicted in FIG. 3 is similar to that presented in FIG. 1, except heat exchanger 140 is in indirect thermal communication with flow pathway 142 via secondary heat transfer fluid 310 that is in fluid communication with secondary heat exchanger 320. In system and method 300, secondary heat transfer fluid 310 is first directly cooled by chilled seawater entering heat exchanger 140 via reservoir outlet line 130, and secondary heat transfer fluid 310 may then promote cooling of inlet air in flow pathway 142, which is in direct thermal communication with secondary heat exchanger 320. While utilization of secondary heat transfer fluid 310 decreases thermodynamic efficiency, benefits of a less corrosive environment in flow pathway 142 and secondary heat exchanger 310 may be realized. In particular, by avoiding contact of flow pathway 142 with seawater, corrosion and/or fouling within flow pathway 142 may be lessened or avoided. Again, it is to be appreciated that the concepts described herein may also be applicable to performing alternative heat exchange processes that do not involve thermal regulation of a flow pathway. Thus, when performing such alternative heat exchange processes, flow pathway 142 need not be present and in direct thermal communication with secondary heat exchanger 310.

FIG. 4 is a diagram of an illustrative system and method for cooling inlet air supplied to a gas engine or gas turbine using a secondary heat transfer fluid cooled with seawater chilled in a liquefied gas vaporizer divided into sections. System and method 400 depicted in FIG. 4 is substantially similar to that presented in FIG. 3, except open rack liquefied gas vaporizer 102 and collection reservoir 120 are subdivided into sections 102a and 102b, and 120a and 120b, respectively, as presented in system and method 200 in FIG. 2. Similar benefits to those described above in reference to FIGS. 2 and 3 may be realized in conjunction with system and method 400 in FIG. 4.

Accordingly, systems for cooling an inlet air stream using seawater may comprise: a liquefied gas vaporizer, such as an open rack liquefied gas vaporizer; a seawater inlet coupled to a supply line configured to distribute seawater upon the liquefied gas vaporizer; a collection reservoir below the liquefied gas vaporizer that is configured to gather chilled seawater passing through the liquefied gas vaporizer; a heat exchanger in fluid communication with the collection reservoir via a reservoir outlet line; and a heat exchanger outlet line coupled to a seawater outlet configured to discharge seawater to a sea location. Pumps, valves, and similar equipment may be utilized to accomplish particular operational and control objectives.

In particular system configurations, the system may be configured to afford cooling of inlet air provided to a gas engine or gas turbine. Namely, the heat exchanger may be in direct or indirect thermal communication with a flow pathway for air provided to a gas engine or gas turbine.

Systems of the present disclosure may further incorporate a gas engine or gas turbine configured to receive an outflow of cooled air supplied from the flow pathway. Suitable examples of gas engines and gas turbines will be familiar to one having ordinary skill in the art. Example systems may include combined cycle power plants using industrial or aeroderivative gas turbines, simple cycle power plants using industrial or aeroderivative gas turbines, and reciprocating piston engines using natural gas or other suitable gaseous fuels, including natural gas mixtures. Industrial processes requiring mechanical power and/or industrial processes combining heat and power generation processes may benefit from the disclosure herein. Systems may include configurations in which the gas engines or gas turbines are installed at an onshore location or on a floating platform. In some system configurations, the gas engine or gas turbine may receive a feed of vaporized fuel gas from the liquefied gas vaporizer (e.g., natural gas, hydrogen, or a combination thereof).

In non-limiting examples, systems of the present disclosure incorporating both a liquefied gas vaporizer and a gas engine or gas turbine may be present in a coupled regasification plant located near or integrated with a near-shore power generation plant, or a floating regasification unit may be integrated with a floating power generation unit.

Systems of the present disclosure may comprise a discharge line extending from the collection reservoir in fluid communication with the heat exchanger outlet line. Optionally, a bypass line may extend from the supply line in fluid communication with the heat exchanger outlet line, such that a portion of the seawater in the supply line is not provided to the liquefied gas vaporizer. Introducing chilled seawater from the discharge line and/or seawater from the bypass line into the heat exchanger outlet line may adjust the seawater temperature within the heat exchanger outlet line before the seawater is discharged into a sea location. In some cases, some of the entering seawater may pass through the bypass line, thereby avoiding the liquefied gas vaporizer and flow pathway altogether (e.g., when the ambient air temperature is low and air cooling needs are minimal, in which case a decreased volume of seawater provided to the liquefied gas vaporizer may support vaporization duty). Preferably, a temperature differential between the seawater inlet and a specified position relative to the seawater outlet may be about 5° C. or less, more preferably wherein the specified position is at a temperature that is about 5° C. or less with respect to the seawater inlet. Prior to dispersion beyond the seawater outlet, the temperature differential between the supply line and the discharge line may be about 15° C. or less, or about 10° C. or less, or about 5° C. or less, such as a temperature differential of about 1° C. to about 10° C., or about 5° C. to about 12° C., or about 3° C. to about 8° C., or about 7° C. to about 13° C., or about 5° C. to about 10° C.

In one example, seawater may be discharged to the sea location in a position to allow optimal mixing and cooling within a thermal plume. Discharged seawater may be within about 3° C. of surrounding water at the edge of a mixing zone or within 100 meters of the seawater outlet. Further details may be specified in International Finance Corporation (IFC) guidelines. Specific requirements in a particular locale may be governed by local regulations.

Chilled seawater provided to the heat exchanger may be in direct thermal communication with the flow pathway (when present) or in indirect thermal communication with the flow pathway (when present) via a secondary heat transfer fluid, which is in fluid communication with a secondary heat exchanger. The secondary heat exchanger, in turn, may be in direct thermal communication with the flow pathway used for cooling the inlet air.

Optionally, the liquefied gas vaporizer and the collection reservoir may each be divided into a first section and a second section. The first and second sections of the collection reservoir may maintain chilled seawater in each section separately and keep them from intermixing with one another. In such embodiments, the supply line may be configured to distribute a first portion of seawater to the first section of the liquefied gas vaporizer and a second portion of seawater to the second section of the liquefied gas vaporizer. Preferably, distribution of the seawater to the first and second sections of the liquefied gas vaporizer may occur at different rates, such that the chilled seawater in the corresponding first and second sections of the collection reservoir have different temperatures. Further, seawater flow rates to the first and second sections may be regulated to achieve active control of the temperatures in the first and second sections of the collection reservoir. Chilled seawater gathered in the first section of the collection reservoir may be obtained from the corresponding first section of the liquefied gas vaporizer, and the chilled seawater collected in the second section of the collection reservoir may be obtained from the corresponding second section of the liquefied gas vaporizer. The discharge line may extend from one section of the collection reservoir. In non-limiting examples, chilled seawater exiting the different sections of the liquefied gas vaporizer may achieve different temperatures by supplying a different amount of seawater per unit contact area within each section of the liquefied gas vaporizer. Higher ratios of seawater per unit contact area and/or per unit volume of vaporized gas (e.g., LNG and/or hydrogen) may afford a smaller temperature decrease in the chilled seawater, and lower ratios of seawater per unit contact area may afford a larger temperature decrease in the chilled seawater. The differing ratios of seawater per unit contact area or per unit volume may be realized by introducing seawater at different flow rates to each section of the liquefied gas vaporizer.

When the liquefied gas vaporizer and the collection reservoir are divided into first and second sections, one of the first section or the second section may be configured to supply chilled seawater to the heat exchanger. A discharge line may extend from the other of the first section or the second section of the collection reservoir and establish fluid communication with the heat exchanger outlet line. Preferably, the section of the collection reservoir having chilled seawater at a lower temperature (T2″) may be provided to the heat exchanger, such as for cooling inlet air, and the section of the collection reservoir having chilled seawater at a higher temperature may be provided to the heat exchanger outlet line to promote thermal regulation therein prior to seawater discharge.

As an alternative to a liquefied gas vaporizer and collection reservoir divided into sections, two liquefied gas vaporizers and collection reservoirs may be operated in parallel in a substantially similar manner to that described in the foregoing, wherein a discharge line extends from one collection reservoir and a reservoir outlet line extends from the other collection reservoir.

In any embodiment herein, the supply line may be capable of distributing seawater upon the liquefied gas vaporizer at a variable rate. Variable-rate distribution of the seawater may be accomplished by a pump capable of conveying a liquid at a variable rate. Suitable examples of variable-rate pumps will be familiar to one having ordinary skill in the art. Flow rate variation may modulate overall flow to the liquefied gas vaporizer and/or to individual sections thereof or to separated liquefied gas vaporizers, which may afford additional thermal regulation capabilities in the disclosure herein.

Optionally, a bypass line may extend from the reservoir outlet line to the heat exchanger outlet line. When air cooling or other heat exchange needs are low, chilled seawater may be diverted through the bypass line. When a bypass line is used in this manner, the second temperature (T2) may be maintained at a substantially constant low value in the reservoir outlet line, and chilled seawater may be provided to the heat exchanger on an as-needed basis to achieve a target temperature in the heat exchanger.

Further optionally, a chilled seawater holding tank may be in fluid communication with the collection reservoir. The chilled seawater holding tank may afford additional operational flexibility, as well as serving as a thermal reservoir for other coupled processes. In the systems and methods of the present disclosure, chilled seawater may be provided from the chilled seawater holding tank to the heat exchanger, the heat exchanger outlet line, or any combination thereof.

Methods of the present disclosure may comprise: providing a flow of liquefied gas in a liquefied gas vaporizer; introducing seawater to a supply line via a seawater inlet; distributing a stream of seawater from the supply line upon the liquefied gas vaporizer, thereby lowering the seawater from a first temperature to a second temperature and forming chilled seawater; gathering the chilled seawater at about the second temperature in a collection reservoir below the liquefied gas vaporizer; supplying a stream of chilled seawater from the collection reservoir to a heat exchanger, the seawater being heated from the second temperature to a third temperature in the heat exchanger and forming heat-exchanged seawater; and removing a stream of heat-exchanged seawater from the heat exchanger via a heat exchanger outlet line. Optionally, the heat exchanger may be in direct or indirect thermal communication with a flow pathway for air provided to a gas engine or gas turbine, as described further herein. As such, the methods may further comprise supplying an outflow of cooled air from the flow pathway to the gas engine or gas turbine. A flow rate of the stream of seawater distributed upon the liquefied gas vaporizer may alter a speed, power, or efficiency of the gas engine or gas turbine, such as in response to particular operational needs.

The liquefied gas may be liquefied natural gas or liquefied hydrogen, and the liquefied gas vaporizer may be a liquefied natural gas vaporizer or a liquefied hydrogen vaporizer. Vaporized natural gas, vaporized hydrogen, or a combination thereof may be supplied to a gas engine or gas turbine receiving inlet air that has been thermally regulated according to the disclosure herein.

The methods may further comprise: discharging the heat-exchanged seawater to a sea location via a seawater outlet. Preferably, a temperature differential between the seawater inlet and a specified position relative to the seawater outlet is about 5° C. or less.

One or more streams of seawater may be introduced to the heat-exchanged seawater at the third temperature prior to discharge to a sea location. In one example, a stream of chilled seawater from the collection reservoir, the reservoir outlet line, or a chilled seawater holding tank may be introduced to the heat exchanger outlet line before discharging the heat-exchanged seawater to the sea location. In another example, a stream of seawater at about the first temperature may be introduced from the supply line to the heat exchanger outlet line before discharging the heat-exchanged seawater to the sea location. Introduction of seawater or chilled seawater from any of these locations may take place, including in combination with one another. Thus, introduction of seawater at the first temperature and/or chilled seawater at the second temperature to the heat exchanger outlet line may afford thermal regulation needed to meet particular discharge requirements.

The systems and methods of the present disclosure may afford more efficient operation of a gas engine or gas turbine by promoting deeper cooling of seawater in liquefied gas vaporizer than would otherwise be possible. In another example, the present disclosure may also afford control of the speed of a gas engine or gas turbine by adjusting the temperature of inlet air supplied thereto. For example, it may be desirable to modulate the power of a gas engine or gas turbine. Thus, methods of the present disclosure may also comprise adjusting a flow rate of the stream of seawater distributed upon the liquefied gas vaporizer to alter a speed of the gas engine or gas turbine.

Embodiments disclosed herein include:

A. Inlet air cooling systems. The systems comprise: a liquefied gas vaporizer; a seawater inlet coupled to a supply line configured to distribute seawater upon the liquefied gas vaporizer; a collection reservoir below the liquefied gas vaporizer that is configured to gather chilled seawater passing through the liquefied gas vaporizer; a heat exchanger in fluid communication with the collection reservoir via a reservoir outlet line; and a heat exchanger outlet line coupled to a seawater outlet configured to discharge heat-exchanged seawater to a sea location.

B. Methods for cooling inlet air. The methods comprise: providing a flow of liquefied gas in a liquefied gas vaporizer; introducing seawater to a supply line via a seawater inlet; distributing a stream of seawater from the supply line upon the liquefied gas vaporizer, thereby lowering the seawater from a first temperature to a second temperature and forming chilled seawater; gathering the chilled seawater at about the second temperature in a collection reservoir below the liquefied gas vaporizer; supplying a stream of chilled seawater from the collection reservoir to a heat exchanger, the chilled seawater being heated from the second temperature to a third temperature in the heat exchanger and forming heat-exchanged seawater; and removing a stream of heat-exchanged seawater from the heat exchanger via a heat exchanger outlet line.

Embodiments A and B may have one or more of the following elements in any combination:

Element 1: wherein the liquefied gas vaporizer is a liquefied natural gas vaporizer or a liquefied hydrogen vaporizer.

Element 1A: wherein the liquefied gas is liquefied natural gas or liquefied hydrogen, and the liquefied gas vaporizer is a liquefied natural gas vaporizer or a liquefied hydrogen vaporizer.

Element 2: wherein the heat exchanger is in direct or indirect thermal communication with a flow pathway for air provided to a gas engine or gas turbine.

Element 3: wherein the heat exchanger is in direct thermal communication with the flow pathway.

Element 4: wherein the heat exchanger is in indirect thermal communication with the flow pathway via a secondary heat transfer fluid that is in fluid communication with a secondary heat exchanger, the secondary heat exchanger being in direct thermal communication with the flow pathway.

Element 5: wherein the system further comprises a gas engine or gas turbine configured to receive a supply of cooled air from the flow pathway.

Element 5A: wherein the method further comprises supplying an outflow of cooled air from the flow pathway to the gas engine or gas turbine.

Element 6: wherein the system further comprises a discharge line extending from the collection reservoir to the heat exchanger outlet line.

Element 7: wherein the system further comprises a bypass line extending from the reservoir outlet line to the heat exchanger outlet line.

Element 8: wherein the liquefied gas vaporizer and the collection reservoir are each divided into a first section and a second section; wherein one of the first section or the second section of the collection reservoir is configured to supply chilled seawater to the heat exchanger via the reservoir outlet line.

Element 8A: wherein the liquefied gas vaporizer and the collection reservoir are each divided into a first section and a second section; wherein one of the first section or the second section of the collection reservoir is configured to supply chilled seawater to the heat exchanger.

Element 9: wherein the system further comprises a discharge line extending from one of the first section or the second section of the collection reservoir to the heat exchanger outlet line.

Element 10: wherein the supply line is configured to distribute a first portion of seawater to the first section of the liquefied gas vaporizer and a second portion of seawater to the second section of the liquefied gas vaporizer.

Element 10A: wherein a first portion of seawater is distributed to the first section of the liquefied gas vaporizer and a second portion of seawater is distributed to the second section of the liquefied gas vaporizer via the supply line.

Element 11: wherein the supply line is configured to distribute the first portion of seawater and the second portion of seawater to the liquefied gas vaporizer at different rates.

Element 11A: wherein the first portion of seawater and the second portion of seawater are distributed to the liquefied gas vaporizer at different rates.

Element 12: wherein the system further comprises a bypass line extending from the supply line to the heat exchanger outlet line.

Element 12A: wherein the method further comprises introducing a stream of seawater from the supply line to the heat exchanger outlet line before discharging the heat-exchanged seawater to the sea location.

Element 13: wherein the system further comprises a chilled seawater holding tank in fluid communication with the collection reservoir.

Element 13A: wherein the method further comprises transferring chilled seawater from the collection reservoir to a chilled seawater holding tank; and supplying chilled seawater from the chilled seawater holding tank to the heat exchanger or the heat exchanger outlet line.

Element 14: wherein the chilled seawater holding tank is in fluid communication with the heat exchanger or the heat exchanger outlet line.

Element 15: wherein the supply line is capable of distributing seawater upon the liquefied gas vaporizer at a variable rate.

Element 16: wherein the liquefied gas vaporizer comprises an open rack vaporizer.

Element 17: wherein the method further comprises adjusting a flow rate of the stream of seawater distributed upon the liquefied gas vaporizer to alter a speed, power or efficiency of the gas engine or gas turbine.

Element 18: wherein the method further comprises discharging the heat-exchanged seawater to a sea location via a seawater outlet.

Element 19: wherein a temperature differential for seawater between the seawater inlet and a specified position relative to the seawater outlet is about 5° C. or less.

Element 20: wherein the method further comprises introducing a stream of chilled seawater to the heat exchanger outlet line before discharging the heat-exchanged seawater to the sea location, the stream of chilled seawater being introduced from the collection reservoir or a reservoir outlet line extending from the collection reservoir to the heat exchanger.

Element 21: wherein a stream of chilled seawater from the collection reservoir is introduced to the heat exchanger outlet line before discharging the heat-exchanged seawater to the sea location, the chilled seawater being introduced from one of the first section or the second section of the collection reservoir.

By way of non-limiting example, exemplary combinations applicable to A and B include, but are not limited to: 1 or TA, and 2, 3 or 4; 1 or TA, and 5 or 5A; 1 or TA, and 2, 3 or 4, and 5 or 5A; 1 or TA, and 6 or 6A; 1 or TA, and 8 or 8A; 1 or TA, and 13; 1, 13 and 14; 1 or TA, and 15; 1 or TA, and 16; 1A and 17; 1A and 18; 1A and 19; 3 or 4, and 5 or 5A; 3 or 4, and 8 or 8A; 3 or 4, and 8 or 8 A, and 9; 3 or 4, 9, and 10 or 10A; 3 or 4, 8 or 8A, and 11 or 11A; 3 or 4, and 15 or 17; 3 or 4, and 16; 3 or 4, and 18; 3 or 4, and 19; 3 or 4, and 20; 3 or 4, and 21; 5 or 5A in combination with any one or more of 1, TA, 2, 3, 4, 6, 7, 8, 8A, 9, 10, 10A, 11, 11A, 12, 13, 14, 15, 16, 17, 18, 19, 20, or 21; 8 or 8A, and 9; 8 or 8A, and 10 or 10A; 8 or 8A, and 11; 8 or 8A, 9, and 11; 8 or 8A, and 13 or 13A; 8 or 8A, and 16; 8A and 17; 8A and 18; 8A and 19; 16 and 17; 16 and 18; 16 and 19; 16 and 20; and 16 and 21.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A system comprising:
a liquefied gas vaporizer;
a seawater inlet coupled to a supply line configured to distribute seawater upon the liquefied gas vaporizer;
a collection reservoir below the liquefied gas vaporizer that is configured to gather chilled seawater passing through the liquefied gas vaporizer;
a heat exchanger in fluid communication with the collection reservoir via a reservoir outlet line; and
a heat exchanger outlet line coupled to a seawater outlet configured to discharge heat-exchanged seawater to a sea location.

2. The system of claim 1, wherein the liquefied gas vaporizer is a liquefied natural gas vaporizer or a liquefied hydrogen vaporizer.

3. The system of claim 1, wherein the heat exchanger is in direct or indirect thermal communication with a flow pathway for air provided to a gas engine or gas turbine.

4. The system of claim 3, wherein the heat exchanger is in direct thermal communication with the flow pathway.

5. The system of claim 3, wherein the heat exchanger is in indirect thermal communication with the flow pathway via a secondary heat transfer fluid that is in fluid communication with a secondary heat exchanger, the secondary heat exchanger being in direct thermal communication with the flow pathway.

6. The system of claim 3, further comprising:
a gas engine or gas turbine configured to receive a supply of cooled air from the flow pathway.

7. The system of claim 1, further comprising one or both of the following: a discharge line extending from the collection reservoir to the heat exchanger outlet line, and a bypass line extending from the reservoir outlet line to the heat exchanger outlet line.

8. (canceled)

9. The system of claim 1, wherein the liquefied gas vaporizer and the collection reservoir are each divided into a first section and a second section; and,
wherein one of the first section or the second section of the collection reservoir is configured to supply chilled seawater to the heat exchanger via the reservoir outlet line.

10. The system of claim 9, further comprising:
a discharge line extending from one of the first section or the second section of the collection reservoir to the heat exchanger outlet line.

11. The system of claim 9, wherein the supply line is configured to distribute a first portion of seawater to the first section of the liquefied gas vaporizer and a second portion of seawater to the second section of the liquefied gas vaporizer.

12. The system of claim 11, wherein the supply line is configured to distribute the first portion of seawater and the second portion of seawater to the liquefied gas vaporizer at different rates.

13. The system of claim 1, further comprising one or both of the following: a bypass line extending from the supply line to the heat exchanger outlet line and a chilled seawater holding tank in fluid communication with the collection reservoir.

14.-15. (canceled)

16. The system of claim 1, wherein the supply line is capable of distributing seawater upon the liquefied gas vaporizer at a variable rate.

17. (canceled)

18. A method comprising:
providing a flow of liquefied gas in a liquefied gas vaporizer;
introducing seawater to a supply line via a seawater inlet;
distributing a stream of seawater from the supply line upon the liquefied gas vaporizer, thereby lowering the seawater from a first temperature to a second temperature and forming chilled seawater;
gathering the chilled seawater at about the second temperature in a collection reservoir below the liquefied gas vaporizer;
supplying a stream of chilled seawater from the collection reservoir to a heat exchanger, the chilled seawater being heated from the second temperature to a third temperature in the heat exchanger and forming heat-exchanged seawater; and
removing a stream of heat-exchanged seawater from the heat exchanger via a heat exchanger outlet line.

19. The method of claim 18, wherein the liquefied gas is liquefied natural gas or liquefied hydrogen, and the liquefied gas vaporizer is a liquefied natural gas vaporizer or a liquefied hydrogen vaporizer.

20. (canceled)

21. The method of claim 18, wherein the heat exchanger is in direct thermal communication with the flow pathway.

22. The method of claim 18, wherein the heat exchanger is in indirect thermal communication with the flow pathway via a secondary heat transfer fluid that is in fluid communication with a secondary heat exchanger, the secondary heat exchanger being in direct thermal communication with the flow pathway.

23.-24. (canceled)

25. The method of claim 18, further comprising:
discharging the heat-exchanged seawater to a sea location via a seawater outlet, wherein a temperature differential for seawater between the seawater inlet and a specified position relative to the seawater outlet is about 5° C. or less.

26.-27. (canceled)

28. The method of claim 18, wherein the liquefied gas vaporizer and the collection reservoir are each divided into a first section and a second section;
wherein one of the first section or the second section of the collection reservoir is configured to supply chilled seawater to the heat exchanger, and
wherein a stream of chilled seawater from the collection reservoir is introduced to the heat exchanger outlet line before discharging to the heat-exchanged seawater to the sea location, the chilled seawater being introduced from one of the first or the second section of the collection reservoir.

29.-34. (canceled)

35. The method of claim 18, further comprising:
transferring chilled seawater from the collection reservoir to a chilled seawater holding tank; and
supplying chilled seawater from the chilled seawater holding tank to the heat exchanger or the heat exchanger outlet line.
